(19) United States
(12) Patent Application Publication
(10) Pub. No.: US 2025/0303329 A1
(43) Pub. Date: Oct. 2, 2025

(54) FILTER WITH METAL-ORGANIC FRAMEWORK FOR CMP PROCESSING

(71) Applicant: Taiwan Semiconductor Manufacturing Company,LTD., Hsinchu (TW)

(72) Inventors: Dai-Shiuan Chiou, Taipei (TW); Jeng-Chi Lin, Hsinchu (TW); Chi-hsiang Shen, Tainan (TW); Chen-Hsueh Lin, Kaohsiung (TW); Tang-Kuei Chang, Tainan (TW); Te-Chien Hou, Kaohsiung (TW); Hui-Chi Huang, Zhubei (TW); Kei-Wei Chen, Tainan (TW)

(21) Appl. No.: 18/616,547

(22) Filed: Mar. 26, 2024

(51) Int. Cl. B01D 39/16; B24B 57/02

(52) U.S. Cl. CPC B01D 39/1623; B24B 57/02; B01D 2239/0492; B01D 2239/0631; B01D 2239/10; B01D 2239/1216; B01D 2239/1233

(57) ABSTRACT

A chemical mechanical polishing (CMP) slurry or a CMP cleaning solution is passed through a filter to remove unwanted ions, while permitting the abrasive particles to still pass through the filter. The filter includes a metal-organic framework (MOF) coating. The filter has both high permeability and high ion absorption. Removal of the ions increases reliability of semiconductor devices produced.

### BACKGROUND

Chemical mechanical polishing (“CMP”) is used in the manufacture of integrated circuits. A combination of chemical and mechanical forces is used to provide a level surface on the top layer of a semiconducting wafer substrate.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1A is a first embodiment of a filter, in accordance with some embodiments. This filter is formed from one layer.

FIG. 1B is a second embodiment of a filter, in accordance with some embodiments. This filter is formed from multiple layers.

FIG. 2A is an illustrative diagram of a pore formed by the fibrous matrix of the filter.

FIG. 2B is an illustrative diagram of a pore formed by the metal-organic framework (MOF) of the filter.

FIG. 3 is a flow chart illustrating a method for making a filter that includes a metal-organic framework coating, in accordance with some embodiments.

FIG. 4 is an illustration of a seeded fibrous matrix.

FIG. 5 is an illustration of a filter formed from a fibrous matrix with an MOF coating.

FIG. 6 is a schematic diagram of a first embodiment of a CMP liquid supply system that uses a filter with an MOF coating.

FIG. 7 is a schematic diagram of a second embodiment of a CMP liquid supply system that uses a filter with an MOF coating.

FIG. 8 is a flow chart illustrating a method for treating a CMP slurry or a CMP cleaning solution, or for removing ions from a CMP slurry or a CMP cleaning solution, in accordance with some embodiments.

FIG. 9A is a side view of a CMP tool, in accordance with some embodiments of the present disclosure. FIG. 9B is a plan view of the CMP tool, showing only some components.

FIG. 10A is a plan view of a schematic diagram for a double-sided brush scrubbing chamber which is part of a post-CMP wafer cleaning tool, in accordance with some embodiments of the present disclosure. FIG. 10B is a side cross-sectional schematic diagram of the double-sided brush scrubbing chamber.

FIG. 10C is a side cross-sectional schematic diagram of a top brush scrubbing chamber which is part of a post-CMP wafer cleaning tool, in accordance with some embodiments of the present disclosure.

FIG. 11 is a plan view schematic diagram of a CMP processing system, in accordance with some embodiments.

FIG. 12 is a flow chart illustrating a method for planarizing a top layer of a wafer substrate, in accordance with some embodiments.

FIG. 13A is a side view of a substrate with two layers thereon, prior to CMP.

FIG. 13B is a side view of a substrate with two layers thereon, after CMP has planarized the top layer.

FIG. 14A is a graph showing the adsorption isotherms for Na+ and K+ ions in Uncoated and Coated filters. The y-axis is the adsorption capacity, and the x-axis is the equilibrium concentration.

FIG. 14B is a bar graph showing the logarithmic concentration of Na+ and K+ ions in the solution after passing through the filters. The y-axis is the In (ion concentration), in parts per billion (ppb).

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Numerical values in the specification and claims of this application should be understood to include numerical values which are the same when reduced to the same number of significant figures and numerical values which differ from the stated value by less than the experimental error of conventional measurement technique of the type described in the present application to determine the value. All ranges disclosed herein are inclusive of the recited endpoint.

The term “about” can be used to include any numerical value that can vary without changing the basic function of that value. When used with a range, “about” also discloses the range defined by the absolute values of the two endpoints, e.g. “about 2 to about 4” also discloses the range “from 2 to 4.” The term “about” may refer to plus or minus 10% of the indicated number.

The present disclosure relates to structures which are made up of different layers. When the terms “on” or “upon” are used with reference to two different layers (including the substrate), they indicate merely that one layer is on or upon the other layer. These terms do not require the two layers to directly contact each other, and permit other layers to be between the two layers. For example all layers of the structure can be considered to be “on” the substrate, even though they do not all directly contact the substrate. The term “directly” may be used to indicate two layers directly contact each other without any layers in between them. In addition, when referring to performing process steps to the substrate or upon the substrate, this should be construed as performing such steps to whatever layers may be present on the substrate as well, depending on the context.

The term “wafer substrate”, as used herein, refers to a substrate or to the combination of a substrate and any layers upon the substrate.

The present disclosure relates to chemical mechanical polishing (CMP) systems. CMP is used to planarize the surface of a wafer using relative motion between the wafer and a rotating polishing pad to which a slurry is applied. Downward pressure is applied to push the wafer against the polishing pad, and elevated elements are worn down to obtain a surface with low surface roughness. A post-CMP cleaning process is then performed using a cleaning solution (which does not contain abrasive particles) that is sprayed on one or both sides of the wafer substrate to remove debris. Ionic species of various elements such as sodium, potassium, calcium, magnesium, aluminum, iron, cobalt, nickel, copper, zinc, manganese, copper, or chromium may be present in the slurry or the cleaning solution. Such ions may potentially become a source of defects, as they could alter the electrical properties of the semiconductor devices on the wafer and result in reliability issues.

In the present disclosure, the CMP slurry and/or cleaning solution are filtered through a filter that comprises at least one layer formed from a fibrous matrix coated with a metal-organic framework (MOF). The filter reduces the concentration of ions, while permitting desired abrasive particles to pass through. The filter possesses both high permeability and high ion absorption, making it effective for controlling ion concentrations in the slurry and/or cleaning solution.

In particular embodiments, the fibrous matrix of the filter is formed from polymeric fibers. The polymer may be, in particular embodiments, polypropylene, polyethersulfone, cellulose acetate, nylon, polyester, polyamide, polyethylene, polytetrafluoroethylene, polysulfone, or polyimide. Homopolymers and copolymers of these polymers may also be used, if desired. In particular embodiments, the fibers in the fibrous matrix may have an average diameter of about 0.1 micrometers (μm) to about 10 μm. This may be measured using conventional methods. However, other ranges and values are contemplated and are within the scope of the present disclosure.

A metal-organic framework (MOF) is a porous three-dimensional extended structure made from metal clusters and organic ligands which are coordinated with each other. The extended structure is formed from sub-units that occur in a constant ratio and are arranged in a repeating pattern. The selection of the metal and the organic ligand affects the structure and the properties of the MOF.

In some particular embodiments, the metal clusters in the MOF include a metal, such as chromium (Cr), iron (Fe), zinc (Zn), gallium (Ga), indium (In), aluminum (Al), scandium (Sc), vanadium (V), titanium (Ti), zirconium (Zr), hafnium (Hf), nickel (Ni), copper (Cu), cobalt (Co), manganese (Mn), magnesium (Mg), or cadmium (Cd). In more specific embodiments, the metal clusters contain Cr, Fe, or Al. It is noted that the MOF generally contains only one metal. In addition, other atoms may also be present in the metal cluster, such as oxygen and hydrogen.

In some particular embodiments, the organic ligands in the MOF comprises organic ligands derived from a carboxylate, pyridine, imidazole, triazole, benzene dicarboxylate, tricarboxylate, naphthalenedicarboxylate, phosphonate, sulfonate, tetrazolate, benzene-1,4-dicarboxylic acid, terephthalic acid, isophthalic acid, 1,2,4-triazole, 1,3,5-benzenetricarboxylic acid, or ethylenediamine. In more specific embodiments, the organic ligands are derived from isophthalic acid.

The MOF is formed as a coating on the fibrous matrix. In particular embodiments, the coating may have a thickness of about 10 angstroms to about 10 micrometers. However, other ranges and values are contemplated and are within the scope of the present disclosure.

In particular embodiments, the weight ratio of the MOF to the fibrous matrix may range from about 1:1 to about 5:1 (i.e. the MOF weighs more than the fibrous matrix). Again, other ranges and values are contemplated and are within the scope of the present disclosure.

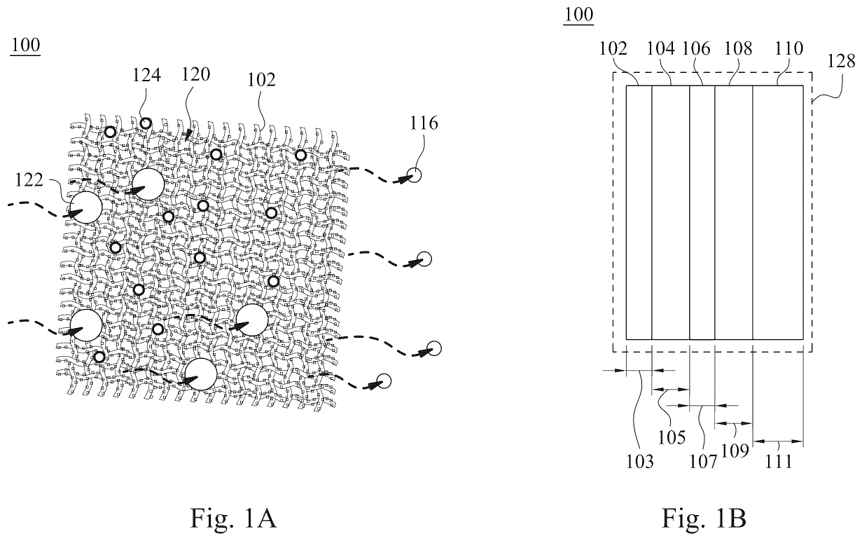

FIG. 1A is a perspective view of a schematic of one embodiment of a filter 100. As illustrated, the filter 100 has one layer 102 formed from a fibrous matrix which is coated with the metal-organic framework (MOF). As illustrated there, the filter has pores 120 which can capture both large particles 122 and ions 124. Abrasive particles 116 can pass through the pores. This filter can be considered a membrane filter, which is formed from one layer and generally has a specific pore size.

FIG. 1B is a side view of a schematic of another embodiment of a filter 100. In this embodiment, the filter 100 is illustrated as having five (5) different layers 102, 104, 106, 108, 110. Each layer may independently have a thickness 103, 105, 107, 109, 111, which may be the same or different. In this illustration, layers 102, 106 are thinner than layers 104, 108, and layer 110 is the thickest layer. The five layers are joined together within a housing 128, which is illustrated in the form of dotted lines. The fibrous matrix, the metal clusters and organic ligands in the MOF, and the pore size of each layer may also be the same or different. This filter can be considered a depth filter, which is formed from many layers and has a thickness greater than that of a membrane filter. Generally, the filter may be formed from one or more layers, or a plurality of layers. In particular embodiments, the filter contains from 1 to about five (5) layers of fibrous matrix coated with an MOF.

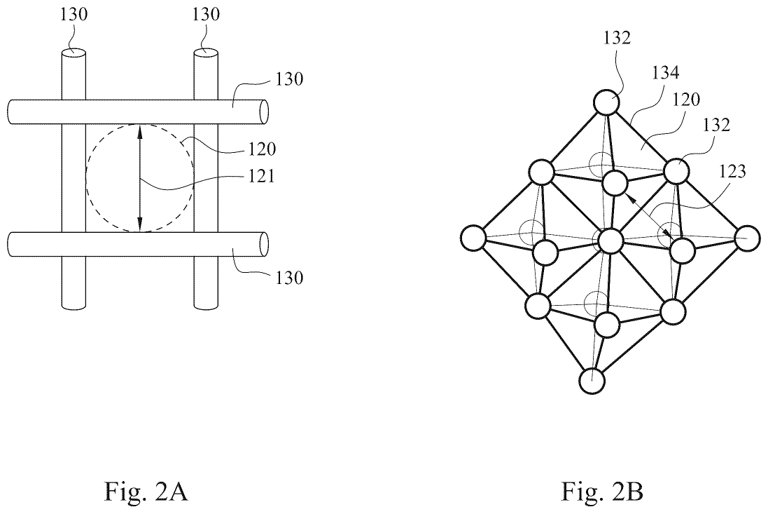

The pores in the filter may be formed from both the fibrous matrix and from the metal-organic framework. FIG. 2A is an illustrative diagram of a pore 120 formed from the fibrous matrix. Here, a pore 120 is formed between four fibers 130. The pore size 121 is the smallest dimension between the four fibers. FIG. 2B is an illustrative diagram of a pore formed from the MOF. Here, a pore 120 is formed by the arrangement of metal clusters 132 and the organic ligands 134. It is noted that the pore size 123 of a pore formed from the MOF may be smaller than or larger than the pore size of a pore formed from the fibrous matrix. In particular embodiments, the filter has a pore size of about 20 nanometers to about 3 micrometers, or a pore size of about 3 micrometers, or about 2 micrometers, or about 1 micrometer, or about 0.7 micrometers (700 nm), or about 0.5 micrometers (500 nm), or about 0.3 micrometers (300 nm), or about 0.1 micrometers (100 nm), or about 0.07 micrometers (70 nm), or about 0.05 micrometers (50 nm), or any range formed by a combination of any two of these values. Other ranges and values are also contemplated and are within the scope of the present disclosure.

In some particular embodiments, the filter contains a MOF coating formed from metal clusters containing aluminum, and organic ligands derived from isophthalic acid. The pore size of the fibrous matrix is about 20 nanometers to about 70 nanometers. Such a filter is particularly suitable for reducing the concentration of nickel (Ni) ions.

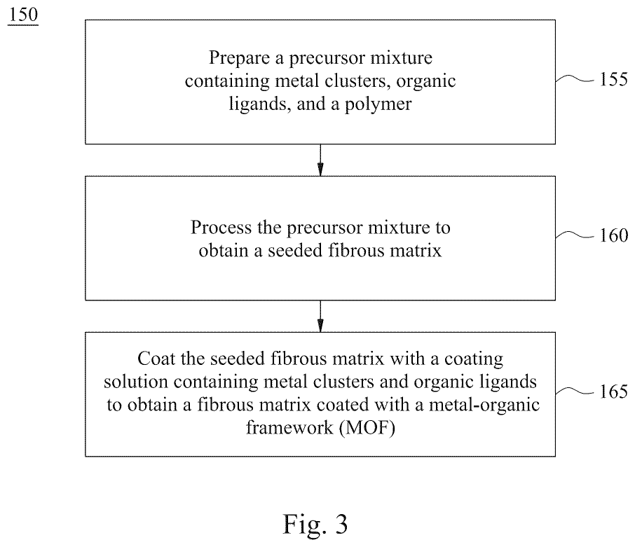

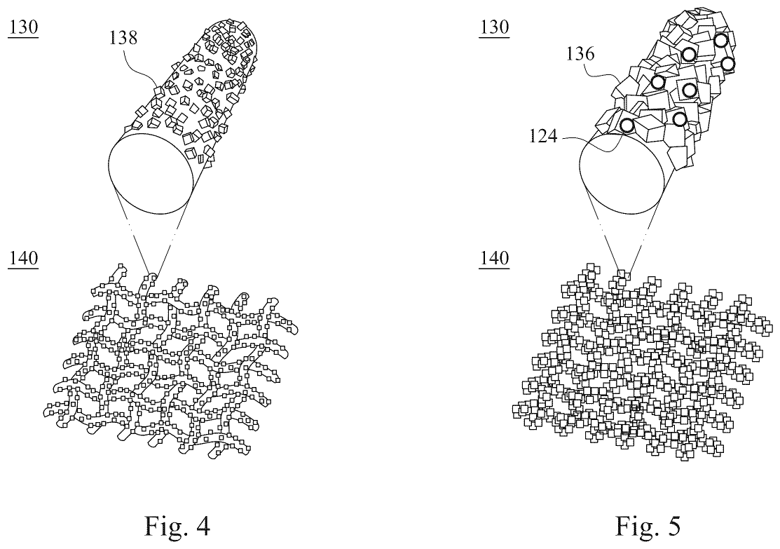

FIG. 3 is a flow chart illustrating a method 150 for making a filter that includes a metal-organic framework coating, in accordance with some embodiments. Some steps of the method are also illustrated in FIGS. 4-5. These figures provide different views for better understanding. While the method steps are discussed below in terms of forming a filter with a single layer, such discussion should also be broadly construed as applying to filters with multiple layers.

In step 155 of FIG. 3, a precursor mixture is prepared. The precursor mixture contains metal clusters and organic ligands for the desired MOF. The precursor mixture also contains a polymer for forming the fibrous matrix. In some embodiments, the precursor mixture may also contain an appropriate solvent to dissolve the polymer. Suitable solvents may include water, alcohols, dimethylformamide (DMF), trifluoroacetic acid (TFA), or combinations thereof. The precursor mixture may be loaded with the metal clusters, organic ligands, and polymer to a desired loading. In some particular embodiments which contain a solvent, the loading of the precursor mixture may be from about 5 wt % to about 60 wt %. Other ranges and values are also contemplated and are within the scope of the present disclosure. Alternatively, the precursor mixture is in the form of a polymer melt, which is a viscous liquid.

Next, in step 160 of FIG. 3, the precursor mixture is processed to obtain a seeded fibrous matrix. The processing may be done, for example, by electrospinning, which can be suitable for both solutions and polymer melts. Various parameters such as the molecular weight of the polymer, viscosity of the precursor mixture, electric potential, flow rate, temperature, humidity, and needle gauge may be controlled as needed to tune the properties of the resulting seeded fibrous matrix. FIG. 4 illustrates the resulting fibrous matrix 140 and a magnified fiber 130. As seen here, the fiber is seeded with metal clusters and/or organic ligands. These can serve as nucleation sites 138 for forming the metal-organic framework.

Then, in step 165 of FIG. 3, the seeded fibrous matrix is coating with a coating solution that contains metal clusters and organic ligands. The metal clusters and organic ligands in the coating solution are the same as those in the precursor mixture. The coating solution may also contain a suitable solvent. The loading of the coating solution may be from about 5 wt % to about 60 wt %. Other ranges and values are also contemplated and are within the scope of the present disclosure. The coating may be performed, for example, by dip coating the seeded fibrous matrix into the coating solution, or by spraying the coating solution onto the seeded fibrous matrix. In some embodiments, the coating may be performed for a time period of about 10 minutes to about 100 hours. The coating can be performed at temperatures ranging from room temperature (about 20° C. to about 25° C.) up to about 150° C. As a result, secondary growth crystallization occurs, which forms an MOF coating upon the fibers of the fibrous matrix. FIG. 5 illustrates the resulting fibrous matrix 140 with an MOF coating 136, and a magnified fiber 130. The coating 136 is visible, and ions 124 are also illustrated as being adsorbed by the coating. It is noted that the coating may also be embedded in or penetrate through the fibrous matrix. Generally, any suitable method for applying an MOF coating to a fibrous matrix may be used.

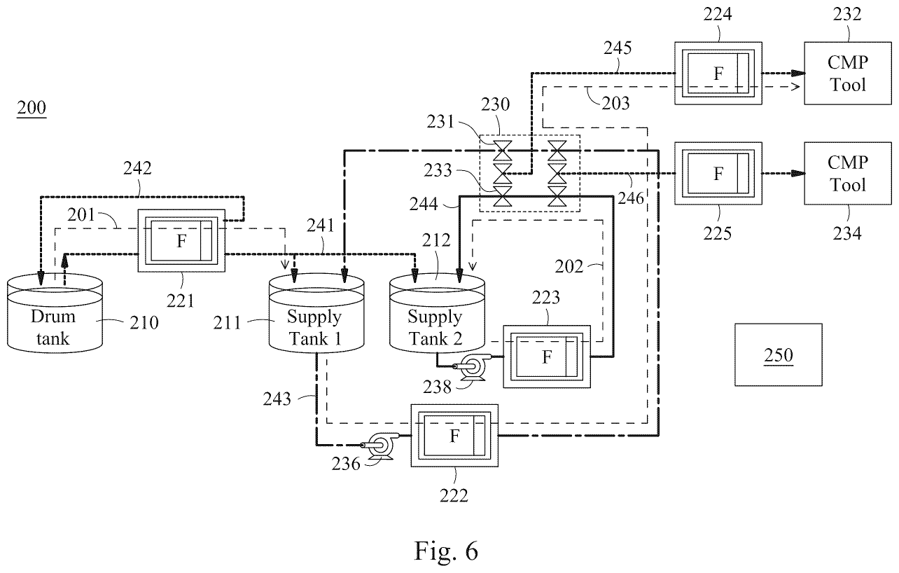

FIG. 6 is a schematic diagram of a first embodiment of a chemical mechanical polishing (CMP) liquid supply system 200 in which the filter is used for reducing ion concentration in the liquid. The liquid may be a CMP slurry or a cleaning solution.

The CMP slurry is a mixture of abrasive particles and fluid(s). The abrasive particles mechanically polish the top layer of the wafer substrate. The composition of the slurry may vary depending on the material that is being polished.

The abrasive particles may be, for example, silica, aluminum oxide ceria, silicon carbide, zirconium oxide, iron oxide, zinc oxide, or titanium dioxide. In particular embodiments, the abrasive particles have a particle size of about 5 nanometers to about 20 micrometers, depending for example on whether the CMP slurry is used for bulk polishing or buff polishing. For example, for bulk polishing, larger particles may be used to provide a faster removal rate. Such particles may range up to 20 micrometers.

However, for a scratch-free buff, fine particles with a particle size of about 5 nm to about 300 nm may be desired. The CMP slurry may contain from about 5 wt % to about 35 wt % of abrasive particles. Other ranges and values are within the scope of this disclosure.

The abrasive particles are usually dispersed in water. If desired, additional fluids that are reactive with the top layer of the wafer substrate may be included, which can aid in the CMP process. For example, the slurry can include an oxidizer to oxidize the wafer surface to form an interface oxide thereon. The interface oxide can be subsequently removed by the pressure and the relative motion between the wafer and the polishing pad during the CMP process. Some examples of oxidizers can include peroxides (e.g., H₂O₂), persulfides, perchlorates, periodates, perbromates, permanganates, chromates, ferrocyanides, and persulfates.

Other additives that can be present in a CMP slurry may include a chelator/complexing agent, a surfactant, a corrosion inhibitor, a dispersant, a lubricant, or an acid/base for pH adjustment. Chelators/complexing agents may include ethylenediamine tetraacetic acid (EDTA) and similar compounds. Surfactants can decrease friction during the polishing process. Suitable surfactants may be nonionic, cationic, or anionic. Specific examples may include sodium dodecyl sulfate, oleic acid, cetyltrimethylammonium bromide, or oleylamine. Corrosion inhibitors may include azoles such as benzotriazole. Some examples of dispersants may include certain phosphates, sulfonates, and polymethacrylates. Some suitable examples of lubricants can include fluorosurfactants, zinc stearate, manganese dioxide, molybdenum disulfide, or aluminosilicates. Some examples of acids and bases for pH adjustment may include hydrochloric acid, nitric acid, phosphoric acid, sulfuric acid, potassium hydroxide, ammonium hydroxide or ethanolamine. Any or all of these chemicals may be present in desired amounts.

The cleaning solution is typically the same as the CMP slurry, but lacking the abrasive particles. For example, deionized water (DIW) alone may be used as a cleaning solution, or the other fluids/additives can also be present.

Referring now to FIG. 6, the system 200 may be generally described as including a liquid flow path that runs from a liquid source through a filter module to a liquid destination. The filter module contains at least one filter comprising at least one layer formed from a fibrous matrix coated with a metal-organic framework (MOF), as described above. In FIG. 6, three such liquid flow paths are illustrated. The first liquid flow path 201 runs from a drum tank 210 through filter module 221 to one or more supply tanks 211, 212. The drum tank is the liquid source, and a supply tank is the liquid destination. The second liquid flow path 202 runs from a supply tank 211, 212 through a filter module 222, 223 and back to the same supply tank 211, 212. In this liquid flow path, the supply tank is both the liquid source and the liquid destination, and may also be referred to as a recycle flow. The third liquid flow path 203 runs from a supply tank 211, 212 through a valve assembly 230 to a CMP tool 232, 234.

Referring now to the system, the drum tank 210 acts as an initial liquid source for the liquid supply system. As illustrated here, a drum tank flow path 241 runs from the drum tank 210 to a first supply tank 211 and a second supply tank 212. The two supply tanks 211, 212 can provide the same liquid or two different liquids that are used for CMP. Such liquids may include, for example, a bulk CMP slurry or a buff CMP slurry or a cleaning solution. Generally, the liquid supply system may include any number of supply tanks. In addition, the drum tank flow path 241 is shown passing through a filter module 221 prior to supplying the two supply tanks 211, 212. A drum tank recycle path 242 is also shown running from the filter module 221 back to the drum tank 210.

Next, a first supply tank flow path 243 runs from the first supply tank 211 through a valve assembly 230 and back to the first supply tank 211. The first supply tank flow path 243 is also illustrated as running through a pump 236 and a filter module 222. Similarly, a second supply tank flow path 244 runs from the second supply tank 212 through the valve assembly 230 and back to the second supply tank 212. The second supply tank flow path 244 is also illustrated as running through a pump 238 and a filter module 223.

Continuing, the liquid supply system is shown as supplying two CMP tools 232, 234. A first CMP tool supply flow path 245 runs from the valve assembly 230 through a filter module 224 to the first CMP tool 232. A second CMP tool supply flow path 246 runs from the valve assembly 230 through a filter module 225 to the second CMP tool 234. Generally, the liquid supply system 200 may be used to supply any number of CMP tools.

As illustrated here, the valve assembly 230 includes a set of valves arranged so that the first CMP tool 232 and the second CMP tool 234 can be independently supplied with liquid from either the first supply tank 211 or the second supply tank 212. In addition, the valves are arranged so that liquid from one supply tank cannot enter another supply tank. Generally, the valve assembly 230 may be used to supply any number of CMP tools. Here, for example, a first valve 231 connects the first supply tank flow path 243 to the first CMP tool supply flow path 245. Similarly, a second valve 232 independently connects the second supply tank flow path 244 to the first CMP tool supply flow path 245. A similar structure connects the two supply tank flow paths to the second CMP tool supply flow path 246.

As illustrated here, five filter modules 221, 222, 223, 224, 225 are shown in the liquid supply system in various locations. A filter module 221 is present between the drum tank 210 and the two supply tanks 211, 212. Filter modules 222, 223 are illustrated between the supply tanks 211, 212 and the valve assembly 230. Filter modules 224, 225 are also illustrated between the valve assembly 230 and a CMP tool 232, 234. The filter modules 221, 222, 223 may be referred to as facility site filters. The filter modules 224, 225 may also be referred to as point-of-use filters. Generally, any number of filter modules may be used, placed in any appropriate location within the liquid supply system. Only one filter module needs to be present in the system, although of course multiple filter modules may be used as desired. One or more filters including a fibrous matrix coated with an MOF as previously described are installed in each filter module in the liquid supply system.

A controller 250 may be used to control/monitor the various components, and to measure various conditions within the liquid supply system. The system may also include sensors (not shown) for monitoring applicable parameters. For example, such sensors may include those for tracking flow rates within the various flow paths, temperature, pressure, amounts within the various supply tanks, the open/closed state of valves within the valve assembly, etc. The controller can also determine when to open/close valves, turn pumps on/off, activate alarms, etc. It is noted that various parameters may not have to be held steady during operation, and could be changed by the controller operating a computer program which alters their setpoints as appropriate. The controller may also include a user interface for communicating with operators. It is also noted that other equipment generally present in such liquid supply systems, such as pipes, pumps, valves, meters, sensors, drains, refill points, etc. are not illustrated in the schematic diagram of FIG. 6.

The controller may be implemented on one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphical card CPU (GPU), or PAL, or the like. Such devices typically include at least memory for storing a control program (e.g. RAM, ROM, EPROM) and a processor for implementing the control program.

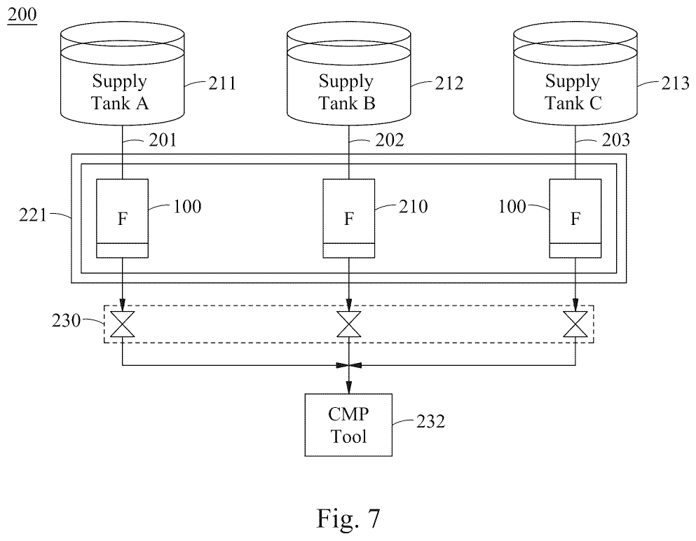

FIG. 7 is an illustration of another embodiment of a liquid supply system 200. Here, three supply tanks 211, 212, 213 are shown. These may be used, for example, to supply a bulk CMP slurry, a buff CMP slurry, and a cleaning solution. Three liquid flow paths are illustrated. A first liquid flow path 201 runs from the first supply tank 211 through a filter module 221 and a valve assembly 230 to the CMP tool 232. A second liquid flow path 202 runs from the second supply tank 212 through the filter module 221 and the valve assembly 230 to the CMP tool 232. A third liquid flow path 203 runs from the third supply tank 213 through the filter module 223 and the valve assembly 230 to the CMP tool 232. Again, the valve assembly 230 includes a set of valves arranged so that the CMP tool 232 can be independently supplied with liquid from any supply tank 211, 212, 213. In this embodiment, the filter module 221 includes three separate filters 210, with each filter being located in a different liquid flow path.

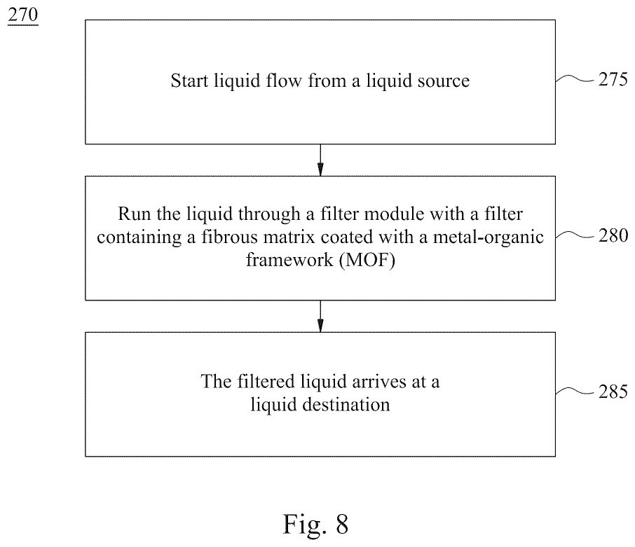

FIG. 8 is a flow chart illustrating a method 270 for treating a CMP slurry or a CMP cleaning solution, or for removing ions from a CMP slurry or a CMP cleaning solution, in accordance with some embodiments. This method is described with respect to FIG. 6 and with respect to only one liquid flow path, but should be broadly construed as applying to the other liquid flow paths.

In step 275 of FIG. 8, a liquid flow is started from a liquid source, such as first supply tank 211. The liquid may be a CMP slurry or a CMP cleaning solution. In step 280, the liquid runs through a filter module that contains at least one filter. The filter contains at least one layer formed from a fibrous matrix coated with an MOF, as previously described. In FIG. 6, this may be either filter module 222 or filter module 224. In step 285 of FIG. 8, the filtered liquid arrives at a liquid destination. In FIG. 6, the liquid destination may be the first supply tank 211 or the first CMP tool 232. The filtered liquid can be collected or used. When desired, the filter can be reactivated, for example by heating the filter to cause the ions to dissociate from the filter. This may occur, for example, at temperatures of about 200° C. to about 600° C.

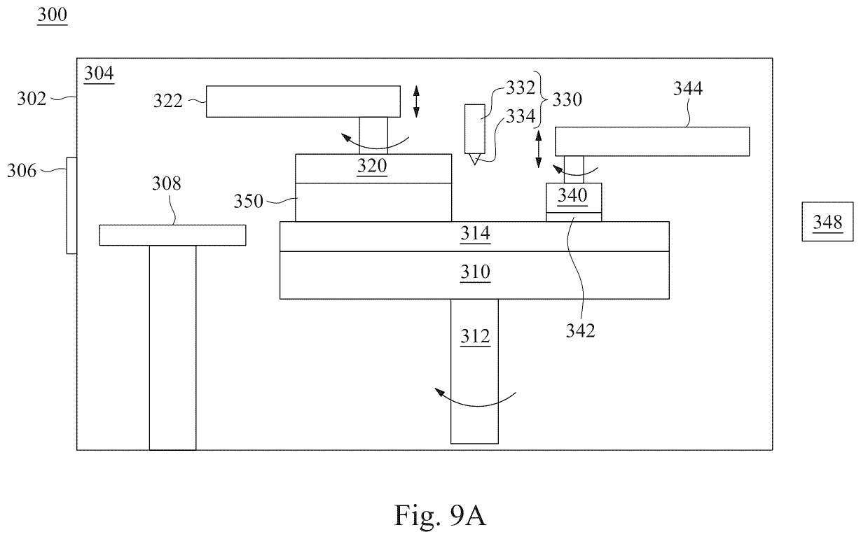

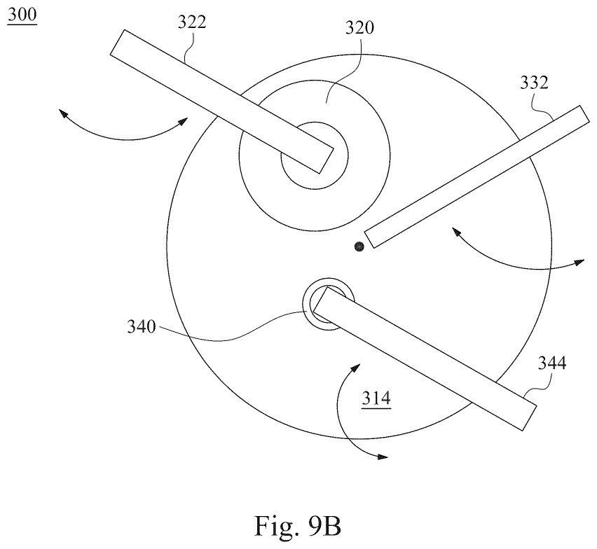

FIG. 9A is a side view of a CMP tool 300, according to some embodiments of the present disclosure. FIG. 9B is a plan view of the CMP tool. It is noted that not all components are illustrated in both figures.

Referring to both figures, the CMP tool 300 includes a housing 302 that contains a chamber 304 for providing a sealed environment for the various components. One or more load ports (not shown) can be coupled to the wall of the chamber 304 to permit wafer substrates to enter and exit the CMP tool 300 using a robotic wafer transfer tool. A door 306 is illustrated which permits access to the chamber 304. A wafer load/unload station 308 is shown, where the wafer substrate 350 is placed.

Continuing, the CMP tool 300 includes a polishing platen 310. The platen is in the form of a flat plate having an upper surface. The platen is attached to a shaft 312, which is coupled to a motor (not shown) for rotating the platen. A polishing pad 314 is attached to the upper surface of the platen. The polishing pad is commonly made from materials that are soft enough not to substantially scratch the wafer, but hard enough to push abrasive particles in the slurry against the wafer to cause mechanical polishing. Examples of such materials may include polyurethane and polyester. The upper surface of the polishing pad may also include high-aspect grooves and asperities between the grooves. The polishing pad has a surface roughness (Ra), which is used for polishing of the wafer substrate. The texture, composition, and/or the structure of the polishing pad may vary depending on the material that is being polished.

The wafer carrier 320 is attached to a robotic arm 322 for moving the wafer carrier between the load/unload station 308 and the platen 310, as indicated in FIG. 9A. The wafer carrier 320 can also be moved up-and-down relative to the polishing pad 314, both for transport and for applying a desired amount of force to press the wafer against the polishing pad 314, as indicated in FIG. 9B. As illustrated here, the wafer substrate 350 is attached to the underside of the wafer carrier.

Continuing, a slurry dispenser 330 is present for applying slurry to the polishing pad 314 during the CMP process. As illustrated here, the slurry dispenser 330 includes an arm 332 and one or more nozzles 334 for dispensing the slurry. The slurry is usually dispensed near the center of the polishing pad, and then travels outwards due to centrifugal forces from rotation of the platen and polishing pad. The arm may also move between the center of the polishing pad and the perimeter of the polishing pad, as indicated in FIG. 9A.

The CMP tool 300 also includes a pad conditioner 340, which is used to condition the polishing pad 314. The removal rate of a polishing pad will decrease over time due to surface degradation, also known as glazing. The pad conditioner removes the glazed surface of the polishing pad, uncovering fresh pad material, and also creates grooves and asperities to provide a more uniform and stable removal rate over time and over the entire surface of the polishing pad.

The pad conditioner 340 is attached to a movable arm 344 which can move between the center of the polishing pad and the perimeter of the polishing pad, as indicated in FIG. 9A. The pad conditioner 340 can also be moved up-and-down relative to the polishing pad 314 for applying a desired amount of force to the polishing pad, as indicated in FIG. 9B. A pad conditioning disk 342 is affixed to the underside of the pad conditioner. The conditioning disk includes diamond particles which are embedded within a matrix. A controller 348 is used to control the various components, and to measure various conditions within the chamber for the CMP process.

During the CMP process, the polishing pad 314 rotates along with the platen 310. The wafer carrier 320 also rotates, causing the wafer substrate to rotate. The polishing pad 314 and the wafer carrier 320 may rotate in the same direction (clockwise or counter-clockwise), or in opposite directions. As they rotate, slurry is deposited upon the polishing pad and flows between the polishing pad 314 and the wafer carrier 320. Through the chemical reaction between reactive chemicals in the slurry and the top layer of the wafer substrate, and further through mechanical polishing due to contact between the abrasive particles in the slurry and the top layer of the wafer substrate, the top layer of the wafer substrate is planarized.

To remove the slurry and the abrasive particles, as well as to remove other small surface defects, a post-CMP cleaning step is used. Such a post-CMP cleaning step can be carried out using a wafer cleaning system that includes rotating scrubber brushes. When actuated, the rotational movement of the brushes, along with a cleaning solution, cleans one or both sides of the wafer substrate using contact pressure against the surface(s) of the wafer substrate.

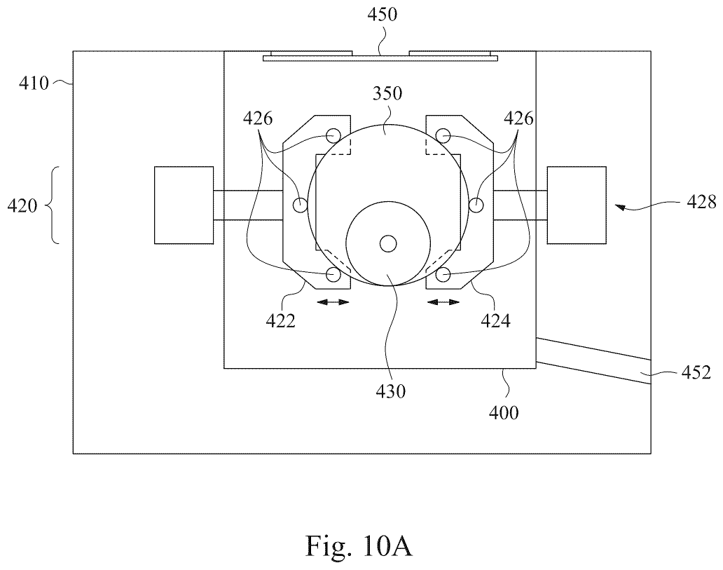

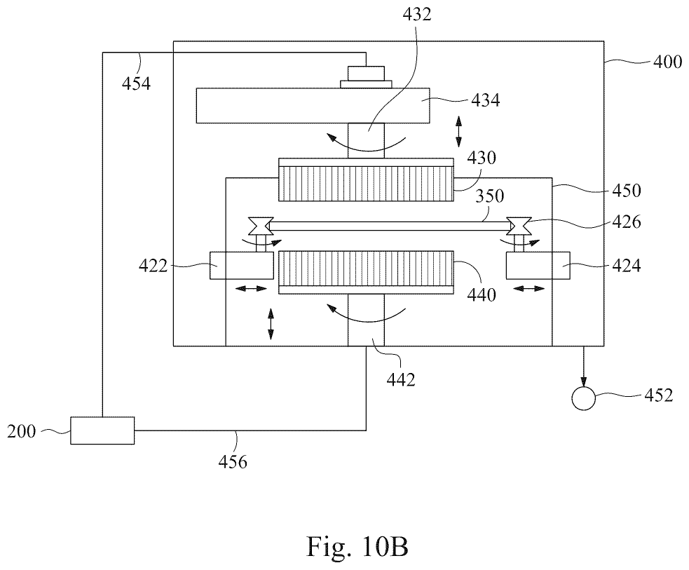

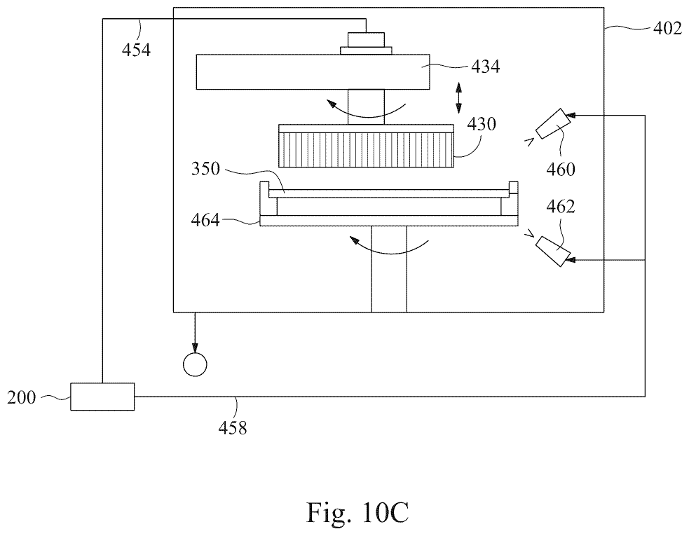

FIG. 10A is a plan view of a schematic diagram for a double-sided brush scrubbing chamber 400 which is part of a post-CMP wafer cleaning tool, in accordance with some embodiments of the present disclosure. FIG. 10B is a side cross-sectional schematic diagram of the double-sided brush scrubbing chamber.

Referring first to FIG. 10A, the double-sided brush scrubbing chamber is contained within a housing 410. The scrubbing action occurs within the chamber to control exposure to fluids. A wafer retention device 420 comprising a pair of retention arms 422, 424 is disposed on opposite sides of the chamber. Each retention arm has three wafer retention rollers 426 thereon, spaced apart. The circumference or perimeter of the wafer 350 is held by each wafer retention roller 426. The retention arm is shaped, and the rollers are spaced apart, such that the rollers are generally disposed about the circumference of the wafer. The retention arms 422, 424 are also movable toward and away from each other, so as to move between a first state where the wafer 350 is held by the wafer retention rollers 426, and a second state where the wafer 350 is released by the wafer retention rollers 426. The retention arms 422, 424 are within the chamber, while their controls and motors 428 are outside the chamber (though within the housing). This permits a wafer to be inserted into or removed from the chamber through the door 450 (in and out of the plane of the page), usually upon a robotic transfer arm (not shown). During the wafer cleaning process, the wafer 350 is rotated by rotating the wafer retention rollers 426, which in turn spins the wafer. Finally, a drain pipe 452 is shown, which is used for draining fluids from the chamber 400.

Referring now to FIG. 10B, the upper brush 430 is attached to an upper arm 434, which can move the upper brush 430 between a first state where the upper brush can clean the wafer, and a second state where the upper brush is moved out of the way so that the wafer can be placed into the chamber or removed from the chamber. In some embodiments, for example where the wafer is inserted from the side, the upper arm only needs to move vertically (i.e. up-and-down). In some embodiments where the wafer is inserted from the top, the upper arm can move vertically and can also move horizontally, so as to be able to move the upper brush out of the way. The lower brush 440 is fixed in place and does not move horizontally (when viewed from above, as in the plan view of FIG. 10A).

The scrubbing/cleaning of the top and bottom surfaces of the wafer 350 is performed by rotating the upper brush 430 and the lower brush 440 with the wafer in between. As previously noted, the wafer 350 is also rotated. The upper brush 430 and the lower brush 440 are located off-center from the center of the wafer 350. In addition, the upper brush 430 and lower brush 440 each may have a diameter greater than the radius of the wafer 350. As a result, the combination of rotations permits the entire surface area on both surfaces of the wafer to be scrubbed/cleaned.

In some embodiments, the shafts 432, 442 to which the upper brush 430 and the lower brush 440 are connected can be hollow, and cleaning solution can be supplied to the brushes through the shafts. Cleaning solution is supplied via fluid supply pipes 454, 456 from a liquid supply system 200, for example those illustrated in FIG. 6 or FIG. 7).

FIG. 10C is a side cross-sectional schematic diagram for a top brush scrubbing chamber 402 which contains only an upper brush and no lower brush. This chamber is generally similar to the double brush scrubbing chamber. The top brush scrubbing chamber 402 includes a wafer holding assembly 464 that holds the wafer 370 in place. During the cleaning process, the wafer holding assembly 464 rotates about its vertical axis, which in turn spins the wafer. As illustrated here, cleaning solution is also supplied through one or more nozzles 460, 462, which also receive cleaning solution via fluid supply pipe 458 from liquid supply system 200.

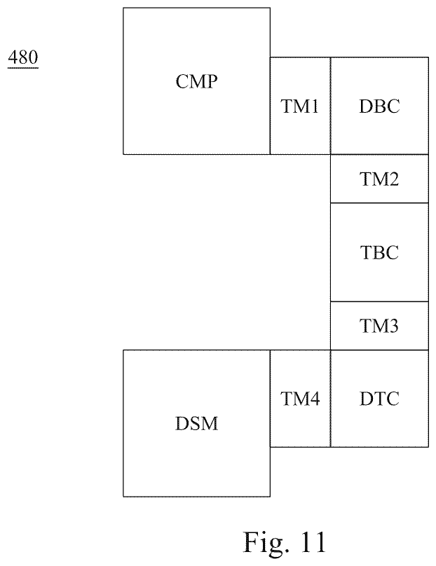

The CMP tool 300 and post-CMP cleaning tool 400, 402 shown in FIGS. 9A-10B may be part of a CMP processing system 480, an example of which is schematically illustrated in FIG. 11. Generally, after the CMP process, Typically, there are three stages in the cleaning process: a scrubbing and cleaning of both sides/surfaces of the wafer in a double sided brush scrubbing chamber, a second scrubbing and cleaning of the top surface of the wafer in a top surface brush scrubbing chamber, and rinsing/drying of the wafer in a dry task chamber.

Referring now to FIG. 11, the CMP tool is labeled CMP. A first transfer module TM1 contains an automated material handling system (AMHS) that transfers the wafer from the CMP tool to a double-sided brush scrubbing chamber DBC. This chamber cleans both sides of the wafer substrate. Next, a second transfer module TM2 contains an AMHS that transfers the wafer from the double-sided brush scrubbing chamber DBC to a top surface brush scrubbing chamber TBC. This chamber TBC cleans only the top surface of the wafer (and does not clean the bottom surface again).

A third transfer module TM3 transfers the wafer from the top surface brush scrubbing chamber TBC to a dry task chamber DTC. The dry task chamber DTC also contains a wafer holding assembly that rotates to dry off the wafer substrate. in addition, the chamber DTC may also contain an ultrasonic cleaning device that operates together with a cleaning fluid to clean off the wafer substrate again. The chamber DTC may also contain a gas drying device that sprays an inert gas (e.g. nitrogen, N₂) upon the wafer substrate during rotation of the wafer holding assembly, to enhance drying. It is possible to perform the drying function of the dry task chamber DTC in the top surface brush scrubbing chamber TBC, if desired. In such embodiments, the third transfer module TM3 and the dry task chamber DTC would be omitted from the system. A fourth transfer module TM4 moves the wafer substrate from the dry task chamber DTC to a downstream module DSM for further processing.

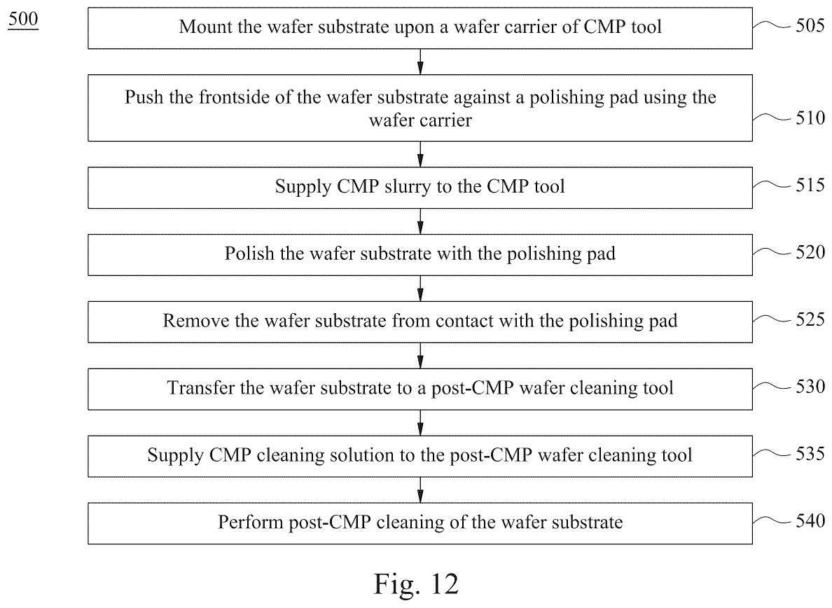

FIG. 12 is a flow chart illustrating a method 500 for planarizing a top layer of a wafer substrate, in accordance with some embodiments. Reference to FIGS. 9A-11 and FIGS. 13A-13B may be helpful for better understanding.

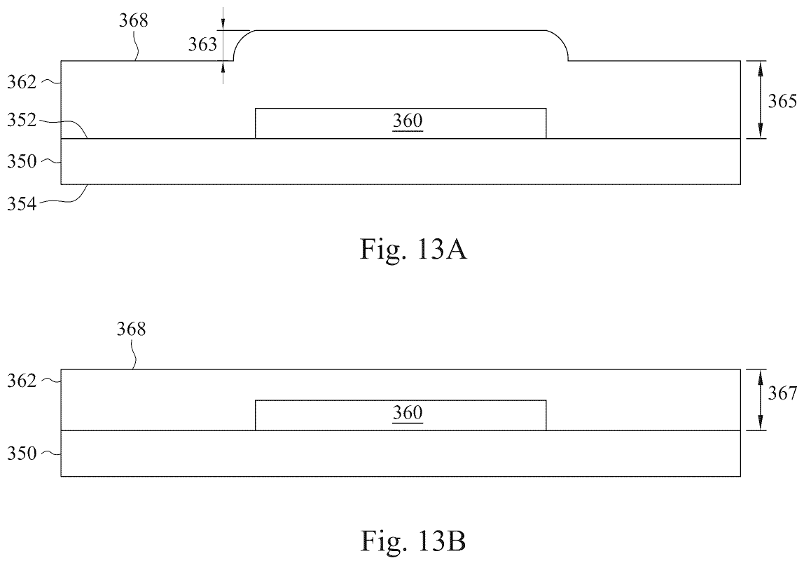

Referring initially to FIG. 13A, an example is shown of a substrate 350 having a frontside 352 and a backside 354. A first layer 360 is present upon the frontside 352, and a second layer 362 covers the first layer 360. The second layer is the top layer 368 of the substrate, or put another way is the outermost exposed layer of the frontside of the substrate. The second layer includes the step height 363 of the first layer 360, and can be thinner over the edges of the first layer. This can be undesirable for high-resolution photolithography which requires height differences to be minimized for accurate printing. Thus, to obtain a level surface, the second layer is deposited to an initial thickness 365 that is greater than the final desired thickness, and CMP is performed to remove the step height.

The substrate 350 may be, for example, a wafer made of a semiconducting material. Such semiconductor materials can include silicon, for example in the form of crystalline Si. In alternative embodiments, the substrate can be made of other elementary semiconductors such as germanium, or may include a compound semiconductor such as silicon carbide (SiC), gallium arsenide (GaAs), gallium carbide, gallium phosphide, indium arsenide (InAs), indium phosphide (InP), silicon germanium, silicon germanium carbide, gallium arsenic phosphide, or gallium indium phosphide. In particular embodiments, the substrate is silicon.

The first layer 360 and the second layer 362 can be a dielectric layer, an electrically conductive layer, a diffusion barrier layer, or any other layer that is useful in a semiconductor device or integrated circuit. Examples of dielectric materials may include silicon dioxide (SiO₂), silicon nitride (Si₃N₄), silicon carbide (SiC), hafnium dioxide (HfO₂), zirconium dioxide (ZrO₂), aluminum oxide (Al₂O₃), silicon oxynitride (SiOₓN_{y}), hafnium oxynitride (HfOₓN_{y}) or zirconium oxynitride (ZrOₓN_{y}), or hafnium silicates (ZrSiₓO_{y}) or zirconium silicates (ZrSiₓO_{y}) or silicon carboxynitride (SiCₓO_{y}N_{z}), or hexagonal boron nitride (hBN). Other dielectric materials may include tantalum oxide (Ta₂O₅), nitrides such as silicon nitride, polysilicon, phosphosilicate glass (PSG), fluorosilicate glass (FSG), undoped silicate glass (USG), high-stress undoped silicate glass (HSUSG), and borosilicate glass (BSG). Examples of electrically conductive materials may include metals such as copper, aluminum, nickel, chromium, gold, germanium, silver, titanium, tungsten, platinum, tantalum, ruthenium, cobalt, rhenium, palladium, or zirconium; composites like TiN, WN, or TaN; or alloys thereof; electrically conductive polymers; and carbon nanotubes. A diffusion barrier layer prevents metals from diffusing into a dielectric layer. Examples of suitable materials that act as a diffusion barrier can include Ti, Ta, Ru, TiN, TaN, or WN.

In step 505 of FIG. 12, the wafer substrate 350 is mounted upon a wafer carrier 320 in a CMP tool 300 (see FIG. 9A). The frontside 352 of the wafer substrate faces the polishing pad 314 of the CMP tool 300. In step 510, the wafer substrate 350 is pushed against the polishing pad 314 by the wafer carrier 320. In step 515, a CMP slurry is supplied to the CMP tool (through the slurry dispenser) and applied to the polishing pad. In step 520, the polishing pad polishes the wafer substrate. The CMP slurry may be continually applied or periodically applied to the polishing pad during the polishing step, as desired. Depending on the degree of polishing needed, the CMP slurry may be a bulk CMP slurry or a buff CMP slurry, or the slurry being provided to the CMP tool can be changed during the polishing step. Once completed, in step 525, the wafer substrate is removed from contact with the polishing pad. The resulting structure is shown in FIG. 13B. The step height is no longer present, and the final thickness 367 of the second layer is less than the initial thickness 365 as shown in FIG. 13A. In step 530, the wafer substrate is transferred from a CMP tool to a post-CMP wafer cleaning tool 400, 402 (see FIGS. 10A-10C). In step 535, a CMP cleaning solution is supplied to the post-CMP wafer cleaning tool and applied to the wafer substrate 350. In step 540, post-CMP cleaning is performed upon the wafer substrate. This can be done by applying the CMP cleaning solution, along with scrubbing the wafer substrate with one or more brushes. The CMP slurry and/or the CMP cleaning solution pass through a filter coated with an MOF as described above.

Use of the filter comprising a fibrous matrix coated with a metal-organic framework (MOF) provides several advantages. Unwanted ions are filtered out of the CMP slurry and/or cleaning solution. Such ions may include sodium, potassium, calcium, magnesium, aluminum, iron, cobalt, nickel, copper, zinc, manganese, copper, and/or chromium. In some embodiments, their concentration can be reduced by at least 20%, or at least 30%, or at least 40%, or at least 50%, or at least 60%, or at least 70%, compared to a filter that is not coated with an MOF. Abrasive particles in the CMP slurry having desired size can still pass through the filter. Because ions are filtered out, semiconductor devices which are subjected to CMP and cleaning are more reliable. Wafer yield is also increased.

The present disclosure thus relates in various embodiments to methods for treating a chemical mechanical polishing (CMP) slurry or a CMP cleaning solution. The slurry or cleaning solution is passed through a filter module containing at least one filter. The filter comprises at least one layer formed from a fibrous matrix coated with a metal-organic framework (MOF).

Also disclosed in various embodiments are chemical mechanical polishing (CMP) liquid supply system, comprising a first supply tank and a valve assembly. A first flow path runs from the first supply tank through the valve assembly and back to the first supply tank. The valve assembly includes a first valve connecting the first flow path to a first CMP tool supply flow path that runs to a CMP tool. A first filter module present in the first flow path or the first CMP tool supply flow path. The filter module contains at least one filter that comprises at least one layer formed from a fibrous matrix coated with a metal-organic framework (MOF).

Other embodiments described in the present disclosure relate to methods for making a filter. A precursor mixture is prepared that contains metal clusters, organic ligands, and a polymer. The precursor mixture is processed to obtain a seeded fibrous matrix (for example, by electrospinning). The seeded fibrous matrix is coated with a coating solution containing metal clusters and organic ligands to obtain a filter that comprises at least one layer formed from a fibrous matrix coated with a metal-organic framework (MOF).

Also disclosed in some embodiments are chemical mechanical polishing (CMP) liquid supply systems that generally comprise a liquid flow path running from a liquid source through a filter module to a liquid destination. The filter module contains at least one filter that comprises at least one layer formed from a fibrous matrix coated with a metal-organic framework (MOF).

The present disclosure also relates to various methods for removing ions from a chemical mechanical polishing (CMP) slurry or a CMP cleaning solution. The slurry or cleaning solution is passed through a filter module containing at least one filter that comprises at least one layer formed from a fibrous matrix coated with a metal-organic framework (MOF).

Still additional embodiments of the present disclosure relate to methods for planarizing a top layer of a wafer substrate. The top layer is pushed against a polishing pad using a wafer carrier to which the wafer substrate is attached. A CMP slurry is applied to the polishing pad. The top layer is polished with the polishing pad to planarize the top layer. The CMP slurry has passed through a filter module containing at least one filter that comprises at least one layer formed from a fibrous matrix coated with a metal-organic framework (MOF).

Also disclosed in various embodiments herein are methods for cleaning a wafer substrate. A cleaning solution is applied to the wafer substrate. The wafer substrate is then scrubbed with a brush. The cleaning solution has passed through a filter module containing at least one filter that comprises at least one layer formed from a fibrous matrix coated with a metal-organic framework (MOF).

Also disclosed in different embodiments are chemical mechanical polishing (CMP) processing systems, comprising a CMP tool and a post-CMP wafer cleaning tool. The CMP tool receives a CMP slurry. The post-CMP wafer cleaning tool receives a CMP cleaning solution. The CMP slurry or the CMP cleaning solution has passed through a filter module containing at least one filter that comprises at least one layer formed from a fibrous matrix coated with a metal-organic framework (MOF). In more specific embodiments, the CMP cleaning solution includes an oxidizer, a chelator/complexing agent, a surfactant, a corrosion inhibitor, a dispersant, a lubricant, and/or an acid/base for pH adjustment, or any combination thereof.

Also disclosed in various embodiments herein are filters that comprise at least one layer formed from a fibrous matrix coated with a metal-organic framework (MOF).

The methods, systems, and devices of the present disclosure are further illustrated in the following non-limiting working examples, it being understood that they are intended to be illustrative only and that the disclosure is not intended to be limited to the materials, conditions, process parameters and the like recited herein.

### EXAMPLES

Experiments were performed in which a filter with a polymeric fibrous matrix was compared to a filter with the same polymeric fibrous matrix. The same solution was passed through both filters, and various measurements were performed.

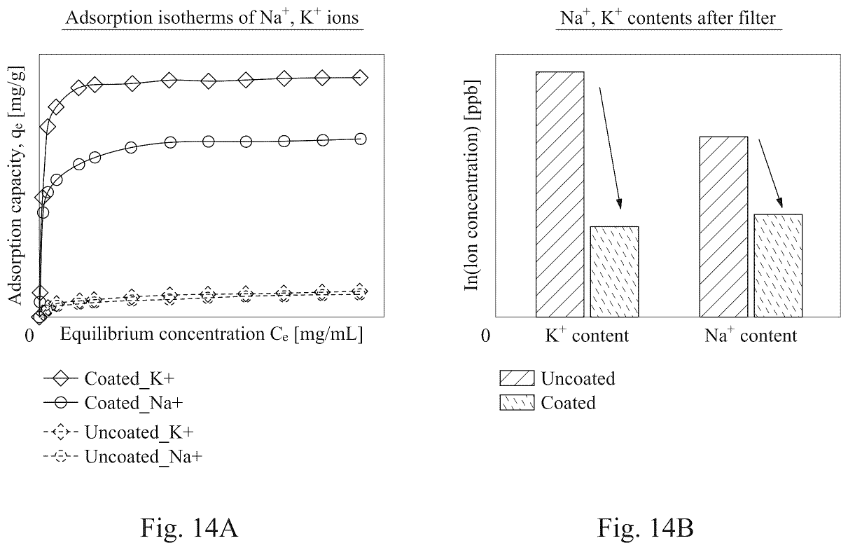

FIG. 14A is a graph showing the adsorption isotherms for Na+ and K+ ions in both filters, which are labeled “Uncoated” and “Coated”. As can be seen here, the adsorption capacity of the Coated filter was much higher than the Uncoated filter for both ions.

FIG. 14B is a bar graph showing the natural logarithmic concentration of Na+ and K+ ions in the solution after passing through the filters. As can be seen here, the concentration was much lower for the Coated filter compared to the Uncoated filter.

Table A below also provides the concentration of some other ions. As can be seen here, ion concentrations were reduced by at least 40%.

TABLE A

| Ion | Uncoated Filter (ppb) | Coated Filter (ppb) | % reduction |
|---|---|---|---|
| Ni | 258.26 | 189.99 | 74 |
| Mn | 57.62 | 27.38 | 48 |
| Cr | 11.63 | 5.38 | 46 |

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method for treating a chemical mechanical polishing (CMP) slurry or a CMP cleaning solution, comprising:
passing the slurry or cleaning solution through a filter module containing at least one filter that comprises at least one layer formed from a fibrous matrix coated with a metal-organic framework (MOF).

2. The method of claim 1, wherein the MOF comprises Cr, Fe, or Al.

3. The method of claim 1, wherein the MOF comprises organic ligands derived from a carboxylate, pyridine, imidazole, triazole, benzene dicarboxylate, tricarboxylate, naphthalenedicarboxylate, phosphonate, sulfonate, tetrazolate, benzene-1,4-dicarboxylic acid, terephthalic acid, isophthalic acid, 1,2,4-triazole, 1,3,5-benzenetricarboxylic acid, or ethylenediamine.

4. The method of claim 1, wherein the MOF comprises metal clusters containing Cr, Fe, or Al, and organic ligands derived from a carboxylic acid.

5. The method of claim 1, wherein the MOF coating has a thickness of about 10 angstroms to about 10 micrometers.

6. The method of claim 1, wherein a weight ratio of the MOF to the fibrous matrix is from about 1:1 to about 5:1.

7. The method of claim 1, wherein the at least one filter has a pore size of about 20 nanometers (nm) to about 3 micrometers (μm).

8. The method of claim 1, wherein the fibrous matrix comprises polypropylene, polyethersulfone, cellulose acetate, nylon, polyester, polyamide, polyethylene, polytetrafluoroethylene, polysulfone, or polyimide.

9. The method of claim 1, wherein fibers in the fibrous matrix have a diameter of about 0.1 micrometers to about 10 micrometers.

10. The method of claim 1, wherein the at least one filter contains 1 to about 5 layers of the fibrous matrix coated with a metal-organic framework (MOF).

11. The method of claim 1, wherein the filter module is located between a supply tank and a CMP tool.

12. The method of claim 1, wherein the filter module is located between a drum tank and a supply tank.

13. The method of claim 1, wherein the slurry or cleaning solution has a reduced concentration of sodium, potassium, calcium, magnesium, aluminum, iron, cobalt, nickel, copper, zinc, manganese, copper, or chromium ions after passing through the filter module.

14. A chemical mechanical polishing (CMP) liquid supply system, comprising:
a first supply tank;
a valve assembly;
wherein a first flow path runs from the first supply tank through the valve assembly and back to the first supply tank;
wherein the valve assembly includes a first valve connecting the first flow path to a first CMP tool supply flow path that runs to a CMP tool; and
a first filter module present in the first flow path or the first CMP tool supply flow path;
wherein the filter module contains at least one filter that comprises at least one layer formed from a fibrous matrix coated with a metal-organic framework (MOF).

15. The system of claim 14, further comprising:
a second supply tank;
wherein a second flow path runs from the second supply tank through the valve assembly and back to the second supply tank;
wherein the valve assembly includes a second valve connecting the second flow path to the first CMP tool supply flow path.

16. The system of claim 14, further comprising:
a drum tank;
a drum tank flow path running from the drum tank through a second filter module to the first supply tank and the second supply tank.

17. The system of claim 16, further comprising a drum tank recycle path running from the drum tank through the second filter module and back to the drum tank.

18. A method for making a filter for chemical mechanical polishing (CMP), comprising:
preparing a precursor mixture that contains metal clusters, organic ligands, and a polymer;
processing the precursor mixture to obtain a seeded fibrous matrix; and
coating the seeded fibrous matrix with a coating solution containing metal clusters and organic ligands to obtain a filter that comprises at least one layer formed from a fibrous matrix coated with a metal-organic framework (MOF).

19. The method of claim 15, wherein the seeded fibrous matrix is coated for a time period of about 10 minutes to about 10 hours.

20. The filter produced by the method of claim 18.
